(19) United States
(12) Patent Application Publication
(10) Pub. No.: US 2015/0053455 A1
(43) Pub. Date: Feb. 26, 2015

(54) CONDUCTIVE LINE AND SPACER FOR CONDUCTIVE LINE

(71) Applicant: SUMITOMO WIRING SYSTEMS, LTD., Yokkaichi (JP)

(72) Inventor: Masahiro HAGI, Yokkaichi (JP)

(21) Appl. No.: 14/459,434

(22) Filed: Aug. 14, 2014

(30) Foreign Application Priority Data
Aug. 23, 2013 (JP) 2013-173022

(51) Int. Cl. H01B 17/16; H01B 7/02

(52) U.S. Cl. CPC H01B 17/16; H01B 7/02
USPC 174/113 C; 174/146

(57) ABSTRACT

To enable a plurality of coated wires inserted in a tubular member to be positioned in a direction intersecting a length direction thereof. A conductive line includes a wire bundle having a configuration in which a plurality of coated wires are bundled together, a tubular member that is arranged so as to surround the wire bundle and that is bent in a state in which the wire bundle is inserted therein, and a spacer that has holding portions formed therein capable of holding the plurality of coated wires in a state in which displacement of the coated wires in a direction intersecting the length direction thereof is restricted, and that is housed in the tubular member.

The present invention relates to a conductive line and a spacer for a conductive line.

### BACKGROUND

JP 2007-080622A discloses a conductive line having a configuration in which a wire bundle formed by bundling together coated wires is inserted in a shield pipe. In addition to the shielding function, the shield pipe also has the protective function for preventing foreign objects from interfering with the wire bundle. When a conductive line of this type is applied to a vehicle, the conductive line is routed in a configuration in which the shield pipe is bent, for example, according to the layout of various devices, the shape of the vehicle and the like. In this case, the shield pipe is bent into a predetermined shape. From the viewpoint of improved workability, the wire bundle is inserted in advance in the shield pipe in a linear state before it is bent, and the shield pipe is bent in a state in which the wire bundle is inserted therein.

JP 2007-080622A is an example of related art.

### SUMMARY

In a case of bending a shield pipe in a state in which a wire bundle is inserted therein, the following problems may arise. When a device that acts as a noise source, such as an inverter, is provided in a vehicle and the conductive line is routed near that noise source, the noise effect exerted on the coated wires constituting the wire bundle is dependent on the positional relationship between the coated wires and the noise source. Accordingly, for an area of the coated wires that is routed near the noise source, it is desirable that the coated wires are positioned such that they are not easily affected by the noise source. However, because the coated wires are housed inside the shield pipe, it is difficult to position the coated wires at an appropriate position.

The present application takes into consideration the above-described situation, and may enable a plurality of coated wires inserted in a tubular member to be positioned in a direction intersecting the length direction thereof.

A conductive line according to an aspect is a conductive line including a wire bundle in which a plurality of coated wires are bundled together;

a tubular member that is arranged so as to surround the wire bundle and that is bent, and

a spacer that has holding portions formed therein capable of holding the plurality of coated wires in a state in which displacement of the coated wires in a direction intersecting a length direction thereof is restricted. The spacer may be housed in the tubular member.

A spacer for a conductive line according to a second aspect is a spacer for use in a conductive line including a wire bundle in which a plurality of coated wires are bundled together, and a tubular member that is arranged so as to surround the wire bundle and that is bent. The spacer may be provided with holding portions capable of holding the plurality of coated wires in a state in which displacement of the coated wires in a direction intersecting a length direction thereof is restricted, the spacer being configured to be housed in the tubular member.

The plurality of coated wires can be positioned in the tubular member in a direction intersecting the length direction thereof by, for example, inserting the spacer into the tubular member with the coated wires being held by the holding portions.

### BRIEF DESCRIPTION OF THE DRAWINGS

FIG. 1 is an external view of a conductive line according to an embodiment;

FIG. 2 is a partial cross-sectional plan view of the conductive line before being bent.

FIG. 3 is a cross-sectional view taken along the line X-X in FIG. 2;

FIG. 4 is a cross-sectional view taken along the line Y-Y in FIG. 2; and

FIG. 5 is a front view of the spacer.

### DETAILED DESCRIPTION

In a conductive line according to an aspect, the conductors constituting the coated wires may be made of a metal, for example, aluminum or an aluminum alloy. Due to their relatively low elasticity and relatively high rigidity, aluminum and aluminum alloys enable the positional relationship of the coated wires relative to the tubular member to be retained even if the wire bundle is housed in a twisted state in the tubular member.

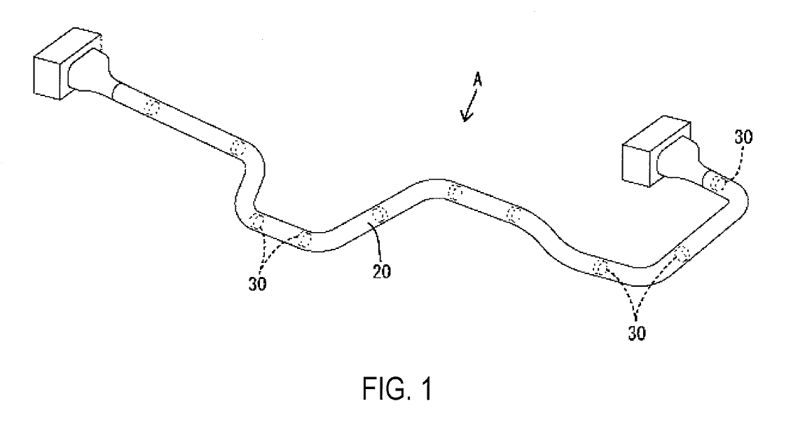

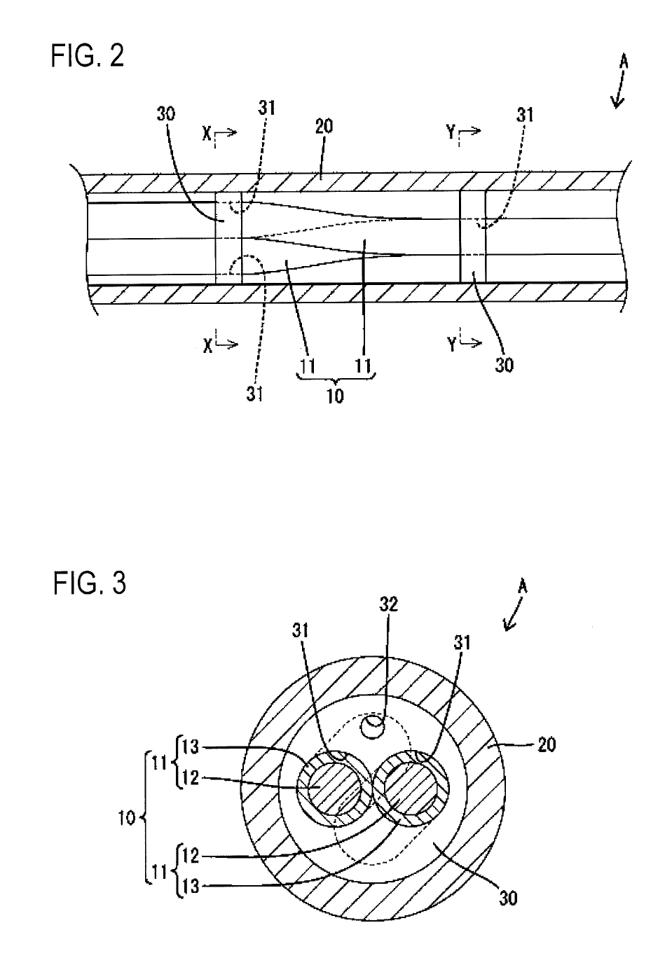

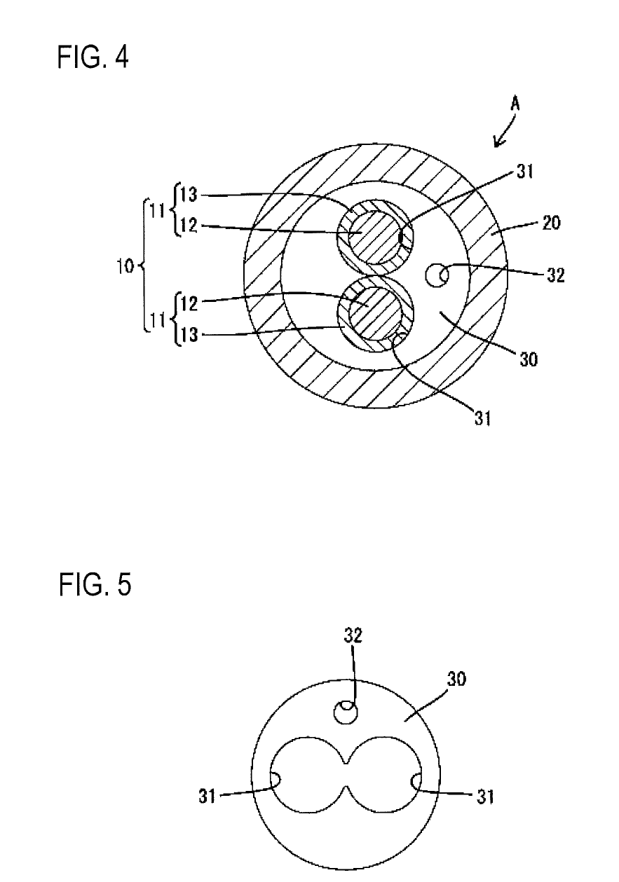

An embodiment will be described below with reference to FIGS. 1 to 5. As shown in FIG. 2, a conductive line A may include a wire bundle 10, a shield pipe 20 (which may correspond to a tubular member), and a plurality of spacers 30. The conductive line A may be configured to be mounted to a vehicle (not shown) such as a hybrid car or an electric car, and to be routed between the motor, the inverter, and the battery.

Note that in the following description the length direction of the wire bundle 10, the routing direction of the wire bundle 10, the length direction of the shield pipe 20, the axial direction of the shield pipe 20, and the direction of extension of the holding hole 31 are all defined to be the same direction.

The wire bundle 10 is formed by bundling together two coated wires 11 substantially parallel to each other. Each of the coated wires 11 has a known configuration in which a cross-sectionally circular conductor 12 made, for example, of aluminum or an aluminum alloy is surrounded by a cylindrical insulating coating 13 made of a synthetic resin. The conductor 12 may be either a single-core wire or a stranded wire obtained by twisting a plurality of elementary wires together. The two coated wires 11 may be identical with respect to the outer diameter of the conductor 12 and the outer diameter of the insulating coating 13.

The shield pipe 20 may be made of aluminum or an aluminum alloy, and its cross-sectional shape is cylindrical. In addition to the shielding function for reducing the effect of noise on the wire bundle 10 by surrounding the wire bundle 10, the shield pipe 20 also has the protective function for protecting the wire bundle 10 from the interference of foreign objects by surrounding the wire bundle 10. The shield pipe 20 may be formed by extrusion into a linear shape, and the wire bundle 10 and the plurality of spacers 30 may be inserted in the shield pipe 20 before it is bent as shown in FIG. 1.

Each of the spacers 30 is made of a synthetic resin (e.g., polypropylene or the like), and is molded into a circular disk shape. As shown in FIGS. 3 to 5, the overall shape of the spacer 30 when viewed from the front may be circular. The outer diameter of the spacer 30 may be set to be the same as or slightly smaller than the inner diameter of the shield pipe 20. The spacer 30 is configured to be inserted into the shield pipe 20, with its front surface being oriented perpendicular to the axis of the shield pipe 20. The spacer 30 inserted in the shield pipe 20 may be configured to be slidable along the axis of the shield pipe 20 while the circumferential surfaces of the spacer 30 and the shield pipe 20 are being brought into sliding contact with each other.

The spacer 30 has a pair of holding holes 31 (which may correspond to holding portions) formed therein extending therethrough in the thickness direction thereof. That is, the number of the holding holes 31 may be the same as the number of the coated wires 11 constituting the wire bundle 10. The holding holes 31 have a circular shape, and a single coated wire 11 is passed through each holding hole 31. The inner diameter of the holding holes 31 may be set to be the same as or slightly smaller than the outer diameter of the coated wires 11. That is, the inner diameter may be set such that the coated wire 11 will not be significantly shifted radially in the holding hole 31, or in other words, the coated wire 11 will not be displaced relative to the holding hole 31 in the direction of extension thereof.

As shown in FIG. 5, the two holding holes 31 amy be connected in a “figure eight” shape when the spacer 30 is viewed from the front. The connecting position between the two holding holes 31 may be located at the center of the spacer 30. Accordingly, the center of each holding hole 31 may deviate from the center of the spacer 30 by an amount corresponding to the radius of the holding hole 31. Thus, when the spacer 30 changes its orientation in a circumferential direction within the shield pipe 20, the two holding holes 31 turn about the connecting portion.

Additionally, the spacer 30 may include a circular inspection hole 32 formed therein extending through a portion located away from the two holding holes 31. The inspection hole 32 makes it possible to inspect whether the plurality of spacers 30 aligned in the length direction of the shield pipe 20 are shifted circumferentially when the spacers 30 are inserted in the shield pipe 20. The inspection may be performed by visual observation by the operator, or by projecting light to the inspection hole 32 from a light-emitting element or the like.

Next, a process for manufacturing the conductive line A according to the present embodiment will be described. First, outside the shield pipe 20, the pair of coated wires 11 may be inserted through the pair of holding holes 31, and the spacer 30 is slid along the wire bundle 10 to be fixed in a predetermined position in the length direction. At this time, the spacer 30 and the wire bundle 10 may be positioned so as be prevented from being displaced relative to each other in the length direction, or in other words, from being shifted, by friction between the inner circumference of the holding holes 31 and the outer circumference of the coated wires 11.

After one spacer 30 has been attached to the wire bundle 10 in the above-described manner, other spacers 30 may be sequentially attached to the wire bundle 10 in the same manner as described above. At this time, the interval between the spacers 30 in the routing direction of the wire bundle 10 is set to be about 200 to 250 mm, for example. After a plurality of spacers 30 have been attached to the wire bundle 10 at appropriate intervals, the wire bundle 10 and the spacers 30 are inserted into the shield pipe 20.

At this time, the insertion stroke may be measured in order to be able to ascertain the positions of the spacers 30 in the shield pipe 20. After completion of insertion of the wire bundle 10 and the spacers 30, the shield pipe 20 is subjected to bending. The bending position, angle, curvature, and direction are set as appropriate according to the shape of, for example, a vehicle to which the conductive line A is to be attached, and the routing path of the conductive line A in the vehicle. After the shield pipe 20 has been bent, the conductive line A is attached to the vehicle, and is routed along a predetermined path.

At the time of inserting the wire bundle 10 and the spacers 30 into the shield pipe 20, anti-noise measures are taken in consideration of the positional relationship between a vehicle-mounted device (not shown) that acts as a noise source and the conductive line A. That is, it is desirable that the orientation of the wire bundle 10 is set such that the distance between one of the coated wires 11 and the noise source is substantially the same as the distance between the other coated wire 11 and the noise source in an area of the conductive line A that is routed near the noise source.

Therefore, in the step of inserting the wire bundle 10 and the spacers 30 into the shield pipe 20, the positions, with respect to the circumferential direction, of the coated wires 11 in the shield pipe 20 may be fixed using the spacers 30 with consideration given to the shape of the shield pipe 20 after bending. For example, the direction in which the two coated wires 11 are aligned horizontally relative to the shield pipe 20 may be set as a reference direction, and the spacers 30 may be rotated in circumferential direction so as to change the orientation of the two coated wires 11 in a twisted manner as shown in FIG. 2. Here, the conductors 12 constituting the coated wires 11 may be made of aluminum or an aluminum alloy, and thus may have small elastic restoring force and high shape retainability. Accordingly, once twisted, the two coated wires 11 can retain the twisted shape.

After predetermined areas of the two coated wires 11 have been twisted as appropriate, the wire bundle 10 and the spacers 30 may be inserted into the shield pipe 20. Thus, the twisted shape of the coated wires 11 may be retained even in a state in which they are inserted in the shield pipe 20, and the twisted shape is also maintained in the step of bending the shield pipe 20. This makes it possible to set the positional relationship of the two coated wires 11 relative to the noise source so as to be suitable for noise reduction. Furthermore, the spacers 30 are substantially in contact with the inner circumference of the shield pipe 20, so that there is no rattling due to their movement in a radial direction. Accordingly, the positional relationship of the coated wires 11 relative to the shield pipe 20 may also be maintained with respect to the radial direction.

The conductive line A includes a wire bundle 10 having a configuration in which two coated wires 11 are bundled together, a shield pipe 20 that is arranged so as to surround the wire bundle 10 and that is bent with the wire bundle 10 being inserted therein, and a plurality of spacers 30. Each of the spacers 30 may have holding holes 31 formed therein capable of holding the two coated wires 11 in a state in which displacement of the coated wires 11 in a direction intersecting the length direction thereof is restricted. Also, the spacers 30 may be housed in the shield pipe 20 in a state in which the coated wires 11 are held by the holding holes 31.

In the state in which the coated wires 11 are held by the holding holes 31 as described above, the plurality of spacers 30 spaced at intervals in the length direction may be inserted into the shield pipe 20 and thereby, the two coated wires 11 can be positioned in the shield pipe 20 in a direction intersecting the length direction (i.e., circumferentially and radially).

Furthermore, in the conductive line A, the conductors 12 constituting the coated wires 11 may be made of aluminum or an aluminum alloy. Due to their relatively low elasticity and relatively high rigidity, aluminum and aluminum alloys enable the positional relationship of the coated wires 11 relative to the shield pipe 20 to be stably retained even if the wire bundle 10 is housed in a twisted state in the shield pipe 20.

Aspects of this application are not limited to the embodiment described by the above statements and drawings, and, for example, the following embodiments also fall within the technical scope of this description.

The number of the coated wires constituting the wire bundle may be two, and the number of the coated wires constituting the wire bundle may be three or more.

The conductors constituting the coated wires may be made of aluminum or an aluminum alloy. The material of the conductors may be copper or a copper alloy.

The tubular member (shield pipe) may be made of aluminum or an aluminum alloy. The material of the tubular member may be a metal other than aluminum and aluminum alloys.

The tubular member (shield pipe) may have a single layer configuration constituted by a single material. The tubular member may have a configuration in which a plurality of tubular layers made of different materials are radially stacked.

The tubular member (shield pipe) may have a circular cross section. The tubular member may have a cross-sectional shape other than a perfect circular shape such as an oval shape or an elliptical shape. In this case, the circumferential positions of the coated wires in the tubular member can be freely set by providing a plurality of types of spacers having holding portions at different positions with respect to the outer circumferential shape are different and placing them in an appropriate manner.

The circumferential positions of the spacers in the tubular member (shield pipe) may be fixed by using the rigidity (shape retainability) of the conductors of the coated wires. The circumferential positions of the spacers in the tubular member may be fixed by fitting together grooves formed in the inner circumference of the tubular member and projections formed on the outer circumference of the spacers. In this case, the circumferential positions of the coated wires in the tubular member can be freely set by providing a plurality of types of spacers whose positions of the holding portions (holding holes) relative to the projections are different and appropriately placing them.

The holding portions (holding holes) may have a closed hole configuration that is not open to the outer circumference of the spacers. The holding portions may have a configuration that is recessed so as to be open to the outer circumference of the spacers.

The plurality of holding portions (holding holes) may be connected with each other, and it is also possible to adopt a configuration in which the plurality of holding portions are not connected with each other.

The number of holding portions (holding holes) formed in a single spacer may be two, or the number of holding portions may be three or more.

All the coated wires constituting the wire bundle may be positioned using the spacers, or only a part of the plurality of coated wires constituting the wire bundle may be positioned using the spacers, and the rest of the coated wires may be freely routed without using the spacers.

The tubular member may a shield pipe having the shielding function. The tubular member may also be a member (e.g., a corrugated tube or the like) that simply protects the wire bundle by surrounding the wire bundle without having the shielding function.

### REFERENCE SIGNS LIST

A Conductive line
10 Wire bundle
11 Coated wire
12 Conductor
13 Cylindrical insulating coating
20 Shield pipe (Tubular member)
30 Spacer
31 Holding hole (Holding portion)
32 Circular inspection hole

What is claimed is:

1. A conductive line comprising:
a wire bundle in which a plurality of coated wires are bundled together;
a tubular member that is arranged so as to surround the wire bundle and that is bent; and
a spacer that has holding portions formed therein, the holding portions being capable of holding the plurality of coated wires in a state in which displacement of the coated wires in a direction intersecting a length direction thereof is restricted,
wherein the spacer is housed in the tubular member.

2. The conductive line according to claim 1, wherein conductors constituting the coated wires are made of aluminum or an aluminum alloy.

3. A spacer for use in a conductive line including a wire bundle in which a plurality of coated wires are bundled together, and a tubular member that is arranged so as to surround the wire bundle and that is bent,
the spacer being provided with holding portions capable of holding the plurality of coated wires in a state in which displacement of the coated wires in a direction intersecting a length direction thereof is restricted, the spacer being configured to be housed in the tubular member.

4. The conductive line according to claim 1, wherein the plurality of coated wires is exactly two coated wires.

5. The conductive line according to claim 1, wherein the tubular member has a single-layer configuration constituted by a single material.

6. The conductive line according to claim 1, wherein the tubular member has a circular cross-section.

7. The conductive line according to claim 1, wherein the tubular member comprises aluminum or an aluminum alloy.

8. The conductive line according to claim 1, wherein the plurality of holding portions are connected to each other.

9. The conductive line according to claim 8, wherein the plurality of holding portions are connected to each other in a figure-eight shape.
